(19) United States
(12) Patent Application Publication
(10) Pub. No.: US 2026/0145245 A1
(43) Pub. Date: May 28, 2026

(54) Method and Device for Producing Micro Parts and Micro Components by Means of Additive Manufacturing Using Micro Laser Sintering

(71) Applicant: 3D Microprint GmbH, Chemnitz (DE)

(72) Inventors: Mario Schneck, Chemnitz (DE); Joachim Göbner, Bürgel (DE); Thomas Starke, Chemnitz (DE)

(21) Appl. No.: 19/118,850

(22) PCT Filed: Jan. 2, 2024
(86) PCT No.: PCT/DE2024/100000

§ 371 Date: Apr. 7, 2025

(30) Foreign Application Priority Data
Jan. 5, 2023 (DE) 10 2023 000 212-7

(51) Int. Cl. B22F 12/52; B22F 10/28; B28B 1/00; B33Y 10/00; B33Y 30/00

(52) U.S. Cl. CPC B22F 12/52; B22F 10/28; B28B 1/001; B33Y 10/00; B33Y 30/00; B22F 2304/10

(57) ABSTRACT

The invention relates to a method and a device for producing micro parts and micro components by means of additive manufacturing using micro laser sintering. A pulverulent agglomerating material (1) is applied in layers from a first powder reservoir (2), and the material is melted using laser light (4) after being applied. The invention is characterized in that the material (1) located in the first powder reservoir (2), which is open in the direction of a processing plane, is an agglomerating powder, the particle size (1) of which equals maximally 20 μm, and a force (F1) is applied to the agglomerating material (1) in the direction of a substrate (3) in a process region (100) at least during the application process, the agglomerating material (1) behaving as a fluid while being applied as a result of said force. For this purpose, the device has a horizontally aligned base (5) which is interrupted at least in some regions in a process region (100) above a substrate (3) and has a first powder reservoir (2) which is arranged above the base (5) in a horizontally movable manner over the base (5) and which comprises an interior for receiving a pulverulent agglomerating material (1), the particle size (1) of which equals maximally 20 μm, wherein the first powder reservoir (2) has a first means (6) in the interior thereof for applying a first axial force (F1), which acts in the direction of the base (5) and the substrate (3), to the pulverulent agglomerating material (1) located in the interior, the agglomerating material (1) behaving as a fluid in the process region (100) at least while being applied as a result of said force.

### CROSS REFERENCE TO RELATED APPLICATIONS

This application is the U.S. national stage of International Application No. PCT/DE2024/100000, filed on 2024 Jan. 2. The international application claims the priority of DE 102023000212-7 filed on 2023 Jan 5; all applications are incorporated by reference herein in their entirety.

### BACKGROUND

The present invention relates to a method for manufacturing micro parts and micro components by additive manufacturing using 3D microprinting and micro laser sintering. According to the preamble of the first claim.

In addition, the present invention relates to a device for carrying out the method according to the invention according to the preamble of the 10^{th} claim.

Micro laser sintering is a powder bed based additive manufacturing technology, often referred to as selective laser sintering or selective laser melting. Micro laser sintering is an industrial technology that provides micro metal parts for various industries.

Laser sintering is a process in which plastic or metal powder is completely melted layer by layer without the use of binders using a laser beam and a homogeneous material with a high density is produced after the melt has solidified.

A 3D CAD model of the target geometry created for this purpose contains all the details of the finished component. This CAD model is divided into several cross-sections, called layers. During production, a thin layer of powder is applied to a substrate. The powder is selectively melted by a laser beam according to each cross-section, The substrate is then lowered, and the process of powder coating, melting and lowering the platform is repeated layer by layer until the part is finished.

Micro laser sintering combines the advantages of additive manufacturing with those of micromachining, In this way, micro metal parts of high precision, detail resolution and surface quality are produced. These advantages make it possible to produce moving parts and assemblies in a single step. The basis for these outstanding results is the combination of a very small laser beam diameter, special micropowder and very thin layers.

The parts are used in all industries that require small metal parts with high accuracy, smooth surface finish, excellent detail resolution and complex shapes. Current main industries are medical, semiconductor, mechanical engineering, aerospace, energy and chemical as well as jewelry and watches.

WO 2018/063969 A1 describes a system comprising as follows: a deposition device configured to deposit powder particles onto a substrate; a laser configured to generate a laser beam for irradiating the deposited powder particles; and an optically transparent press configured to apply mechanical pressure to the deposited powder particles during irradiation thereof by the laser beam, wherein the laser beam irradiates the deposited powder particles through the optically transparent press. The disadvantage is that the pressure exerted during laser irradiation makes it more difficult to create structures with an irregular surface, because the shape of the manufactured component is already predetermined by the structure of the press.

CN 113458421 A discloses a plant system and a method for improving the quality of a powder bed in an additive manufacturing process. The plant system comprises a spatially displaceable scattering device for powder and an excitation unit, wherein the scattering device is arranged for applying one or more powder layers on a processing plane to a substrate platform or a powder bed processed with the plant system. The excitation unit is arranged to break clusters and/or adhesions between particles of the individual powder and/or between particles of the individual powder and a powder bed that has been treated with the plant system, so that the powder scattering device can apply a smooth powder layer to the substrate platform and/or the previous powder layer/bed.

Powder accumulations are dissolved by introducing vibrations, which can be generated pneumatically, electromagnetically or by introducing ultrasound.

Other publications that propose the introduction of vibrations include DE 10 2016 202 696 B4 or EP 3 292 989 A1.

The publication DE 11 2008 000 027 T5 discloses a “laminating forming device” with which a high-precision multilayer object with a compact design can be produced. The prior art cited therein discloses that a lifting table for lifting the shaping plate and a shaping frame which encloses the lifting table are provided. A lowering of a shaping plate and a raising of a lifting table are performed in a single step. The powder has an average particle size of 20 μm, so particles larger than 20 μm are always present, which is not suitable for some applications.

Publication DE 10 2016 107 769 A1 relates to additive manufacturing and handling mechanisms for additive manufacturing. The particle size is not discussed here and it is not disclosed that an agglomerating powder is used. In this solution, powder is to be recovered.

For example, the publication DE 10 2017 124 047 A1 discloses a composition for use in additive manufacturing processes in which an anti-agglomeration agent is used to prevent agglomeration of the powder used. This requires increased effort and these agents can change the chemical composition of the materials used. This can be an exclusion criterion, especially in the medical device sector. Devices that remain in the body for a long time and, of course, implants are critical. Furthermore, these additives can burn or vaporize completely or partially when the metal powder is melted during the additive process. This can lead to defects, cavities or voids in the material structure of the component. There is a risk of deterioration in the mechanical, chemical and electrical properties of the components. These risks are particularly high in the production of small components with small wall thicknesses in the micrometer range-as is the case with micro laser sintering. A defect of 3 micrometers in a 100 micrometer thick wall, for example, represents a weakening of 3 percent and is therefore significant. The disadvantage of previous methods and devices is that the reliable and uniform application of the powder is sometimes not guaranteed due to the very small particle size, which has a negative impact on the quality of the components.

### SUMMARY

The invention is thus based on the object of providing micro parts and micro components which have an improved quality compared to the prior art, in particular when using an agglomerating powder with a small particle size.

The problem is solved by the features of independent claim 1 and by the features of independent claim 10. Further useful designs of the invention are the subject matter of the dependent claims.

### DETAILED DESCRIPTION

This problem is solved by a method and a device for producing micro parts and micro components by means of additive manufacturing using micro laser sintering, wherein a pulverulent agglomerating material (hereinafter referred to as pulverulent material) is applied in layers from a first powder reservoir and is melted by means of a laser beam after application, wherein, according to the invention, the pulverulent material in the first powder reservoir is subjected to a force, wherein the force acts both when the first powder reservoir is filled and when it passes over a base plate and when it is applied to the substrate.

The force applied to the pulverulent material can, for example, be provided mechanically by spring force and/or by an electric motor and/or by pneumatics and/or hydraulics.

In particular, the method comprises the following steps:
a. Compaction of the pulverulent material in a first powder reservoir open in the direction of a processing plane by exerting axial pressure on the pulverulent material in the direction of the substrate;
b. Application and formation of a first powder layer of the pulverulent material on an upper surface of a substrate by moving the first powder reservoir parallel to the upper surface of the substrate while simultaneously exerting force on the pulverulent material in the direction of the upper surface of the substrate;
c. Selective melting of the first powder layer using a laser beam;
d. Lowering the substrate and
e. Application of the compacted pulverulent material from the first powder reservoir with simultaneous application of force to the pulverulent material on the first selectively melted powder layer or on further already formed and selectively melted powder layers and formation of further powder layers which are selectively melted until completion of the micro part or micro component, wherein the substrate is lowered before the application of each further powder layer.

It may also be provided that the pulverulent material is stored in a second powder reservoir, from which it is conveyed and/or pressed into the first powder reservoir. Preferably, the pulverulent material is already pre-compacted in the second powder reservoir and may be further compacted in the first powder reservoir.

The agglomerating material is preferably pressed from the second powder reservoir into the first powder reservoir with a second force of 30N to 50N.

The application of force during application ensures that the agglomerating powder is applied evenly and adheres reliably to the substrate.

Preferably, a first force always acts vertically downwards towards the substrate and the base plate during the entire application process.

This first force is constant.

The constant first force acts when passing over the base plate and the substrate and preferably also when filling the first reservoir.

The first force is intended to ensure that the agglomerating material behaves like a fluid, particularly when it is applied to the substrate and the other layers that have already melted and solidified over the substrate.

The anti-agglomeration agents previously used in the prior art are not required with the solution according to the invention.

The first force applied is 5 N to 50 N, particularly in the process range.

Tests have shown that with this force the agglomerating powder, which has a maximum particle size of 20 μm, behaves like a fluid, which ensures that it is applied more evenly.

Preferably, when compacting the pulverulent material in the first powder reservoir, a counterforce is exerted simultaneously with the compacting force in order to ensure uniform compaction. The counterforce can be provided, for example, by a horizontal base plate over which the first powder reservoir is moved before the first powder layer is applied.

Preferably, the substrate is lowered according to the required layer thickness of the next powder layer to be produced.

As an alternative to lowering the substrate, the processing plane and the first powder reservoir, and possibly other components that are present for carrying out the method, can be raised in such a way that their distance to a fixed substrate increases in accordance with the required layer thickness of the next powder layer to be produced.

Preferably, the micro part or micro component is separated from the substrate after completion of the micro part or micro component. The separation is preferably carried out by wire erosion. In order to use the substrate for a renewed performance of the method according to the invention, any component residues remaining on the substrate after wire erosion are ground off and the substrate surface is structured.

Advantageously, the substrate is structured before the pulverulent material is applied in such a way that the structure of the substrate surface is essentially adapted to the particle size of the pulverulent material. The structuring may have depressions whose size corresponds to 0.5 to eight times the particle size of the pulverulent material. Advantageously, the individual particles of the pulverulent material remain in the depressions, which ensures that the pulverulent material adheres to the substrate surface.

Preferably, an infrared fiber laser is used to melt the first and/or further powder layers.

It may be provided that laser sintering can be carried out under inert gas, which can be argon, for example.

A metallic material is preferably used as the powder material. Alternatively, a ceramic powder can be used.

It is also possible to process various metallic powders and/or ceramic powders.

In particular, stainless steel and/or titanium is used as the powder material. Preferably, the particle size of the agglomerating pulverulent material is a maximum of 20 μm.

The problem is further solved by a device for carrying out the method according to the invention, comprising a horizontally aligned processing plane and a first powder reservoir arranged above the processing plane and horizontally movable on the processing plane and having an interior for receiving a pulverulent material. According to the invention, the first powder reservoir is designed to be open in the direction of the processing plane and the first powder reservoir has in its interior a means for generating an axial force acting in the direction of the processing plane on the pulverulent material located in the interior, as a result of which the agglomerating material 1 behaves like a fluid at least during application in the process region 100.

The means for generating the axial force is preferably a plunger, the dimensions of which completely or almost completely cover the cross-section of the interior of the first powder reservoir. The force transmitted to the pulverulent material by the means for generating the axial force can be provided mechanically by means of a spring and/or electrically and/or pneumatically and/or hydraulically.

It may be provided that the first powder reservoir has a measuring device in its interior with which the quantity of pulverulent material present in the first powder reservoir can be determined.

In particular, the device has a substrate arranged below the processing plane for holding a first powder layer.

The substrate preferably has a substrate surface which acts, for example, like the surface of the agglomerating pulverulent material. Preferably, forces act between the substrate surface and the pulverulent material so that the applied pulverulent material remains on the entire surface of the substrate,

It may be provided that the structuring of the substrate surface has depressions whose size corresponds to 0.5 to eight times the particle size of the pulverulent material. Advantageously, the individual particles of the pulverulent material remain in the depressions of the substrate surface, which ensures that the pulverulent material reliably adheres to the substrate surface as the first layer.

In a preferred embodiment, the device according to the invention further comprises a second powder reservoir arranged below the processing plane and having an interior for receiving a pulverulent material, wherein the second powder reservoir is designed to be open in the direction of the processing plane and wherein the second powder reservoir has in its interior second means for generating an axial force acting in the direction of the processing plane on the pulverulent material located in the interior and is provided for filling the first powder reservoir.

The second means for generating the axial force in the second powder reservoir can also be a plunger, the dimensions of which completely or almost completely cover the cross-section of the interior of the second powder reservoir. The force transmitted to the pulverulent material by the second means for generating the axial force can be provided mechanically by means of a spring and/or electrically and/or pneumatically and/or hydraulically.

The second powder reservoir is preferably in the form of a cartridge prefilled with powder, the lower base of which can be displaced in the direction of the first powder reservoir using the second force.

While the first powder reservoir is moved horizontally over the base plate, the base plate exerts a counterforce to the axial force, which is exerted by the means or multiple means arranged in the first powder reservoir to generate the axial force.

Advantageously, the base plate is at least partially interrupted in a process region above the substrate. The interruption of the base plate above the substrate makes it possible for the pulverulent material from the first powder reservoir to be applied to the substrate surface.

It may also be provided that the base plate is interrupted at least in some areas in a filling region above the second powder reservoir. The interruption in a filling region makes it possible for the pulverulent material to be pressed from the second powder reservoir located below the filling region into the first powder reservoir located above the filling region. Preferably, the first and second powder reservoirs have the same opening surface for this purpose, via which the respective interior of the first and second powder reservoirs is open towards the interruption of the base plate in the filling region.

Preferably, the device has a laser for melting the first powder layer and/or further powder layers. It may also be provided that the laser can also be used to structure the surface of the substrate. The laser is preferably an infrared fiber laser. The laser beam is deflected in a known manner via one or more mirrors.

The invention advantageously makes use of the powder-inherent forces of the powder, which are also responsible for the agglomeration/clumping that is not usually desired. In particular, by applying energy to the pulverulent material, the otherwise disruptive powder-hardening forces are overcome.

### BRIEF DESCRIPTION OF THE DRAWINGS

The invention is explained in more detail below with reference to exemplary embodiments and associated figures, without being limited to these, wherein:

FIG. 1 shows the method steps of micro laser sintering according to the prior art;

FIG. 2 shows a schematic representation of the filling process of the first powder reservoir;

FIG. 3 shows the application of the first powder layer using the first reservoir;

FIG. 4 shows the melting of the required areas of the first layer using a laser beam;

FIG. 5 shows the application of a further layer of the powder with the substrate lowered;

FIG. 6 shows a device for unidirectional application of the powder with a recess on one side in the base plate;

FIG. 7 shows a device for bidirectional application of the powder with recesses on both sides of the substrate in the base plate;

FIG. 8 shows a device for bidirectional application of the powder with barriers on two bars in a recess in the base plate and on both sides of the substrate;

FIG. 9 shows a device for bidirectional application of the powder with barriers on two bars on the upper side of the base plate and on both sides of the substrate;

FIG. 10 inclined first powder reservoir.

### DETAILED DESCRIPTION OF THE PREFERRED EMBODIMENTS

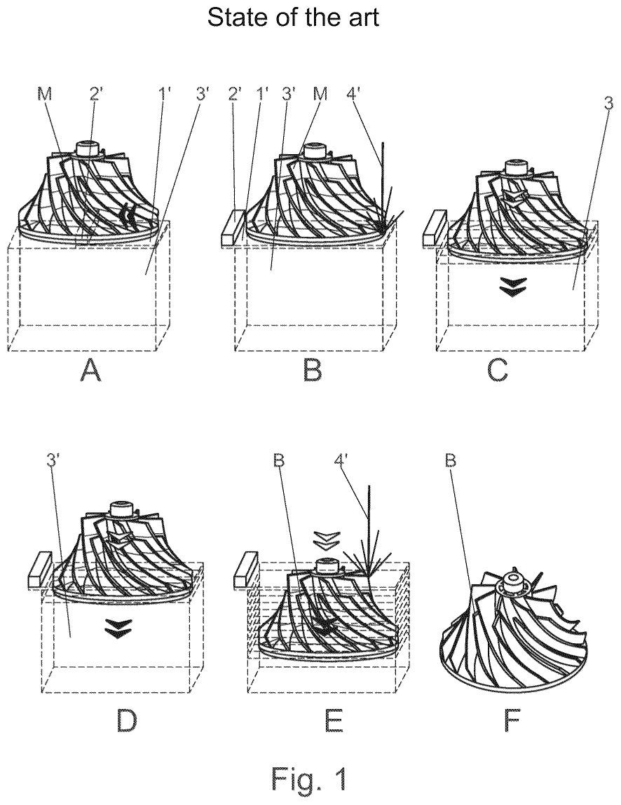

FIG. 1 shows the method steps for manufacturing a component according to the prior art. A three-dimensional CAD model M of the product was created, from which a component is then produced by additive manufacturing using micro laser sintering. For this purpose, a powder reservoir 2′, in which fine-grained pulverulent material 1′is located, moves in a first step over the surface of a substrate 3′, to which a thin layer of powder adheres, as shown in diagram A. Then, according to step B, the pulverulent material 1′on the substrate is melted by means of a laser beam 4′at the positions at which it is to solidify. In step C, the substrate 3′is lowered by the amount of the next layer thickness to be produced. A further layer of the material 1′is applied to the first layer using the powder reservoir 2′, which moves horizontally over the already solidified layer and then this layer is also melted using the laser beam 4′and thereby solidified (not shown). Now the substrate 3′is lowered down again (Fig. D) and coated again with the pulverulent material 1′and so on until the component B is finished according to the CAD model M as shown in Fig. E by micro laser sintering using the laser beam 4′. Unmelted powder is removed. Fig. F shows the finished component B, which has been detached from the substrate.

A disadvantage of the prior art is that the powder does not adhere to the entire surface during application, which can result in imperfections.

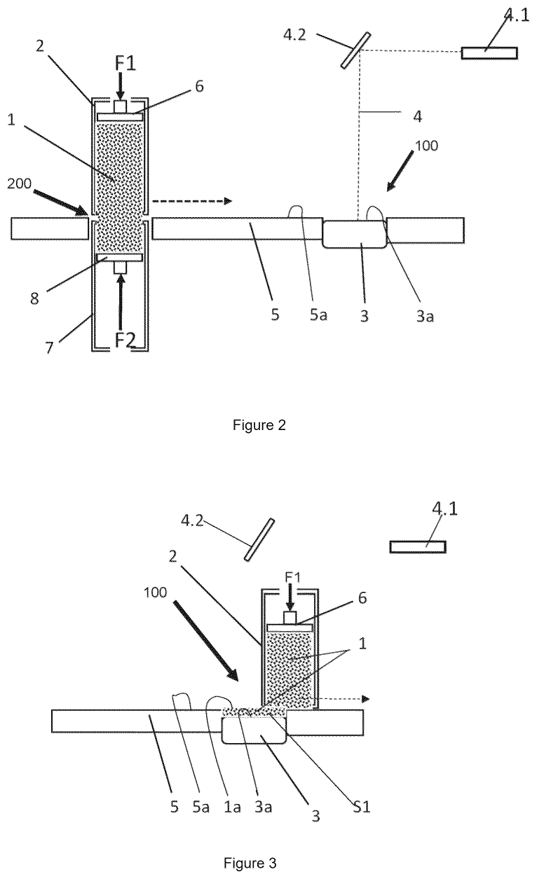

FIG. 2 shows a schematic representation of a first step of the method according to the invention, carried out on a device according to the invention.

The device has a base plate 5 with an upper side 5a, a first powder reservoir 2 arranged above the upper side 5a and a second powder reservoir 7 arranged below the upper side 5a. In FIG. 2, both the first powder reservoir 2 and the second powder reservoir 7, which is preferably provided as a prefilled cartridge, are located in a filling region 200 of the device, in which the base plate 5 has an undesignated interruption.

In the first powder reservoir 2 there is a first means 6 for generating an axial force F1, by means of which the powder material 1 in the interior of the first powder reservoir 2 is subjected to an axial force F1 in the direction of the base plate 5.

In an interior of the second powder reservoir 7 there is a pulverulent material 1 which is acted upon by a second means 8 for generating a second axial force F2 acting in the direction of the first powder reservoir 2, indicated by an arrow in the figures. In the embodiment shown, the second means 8 for generating a second axial force F2 is a plunger which, for example, can also be the base of the cartridge (which forms the second reservoir 7), which is axially adjustable within the circumferential wall (not indicated) in the direction of the first reservoir 2.

The pulverulent material 1 is thus conveyed from the second reservoir 7 into the interior of the first powder reservoir 2 and compressed in it.

Since both the first powder reservoir 2 and the second powder reservoir 7 are open towards the base plate 5 in the filling region 200, the pulverulent material 1 is pressed into the interior of the first powder reservoir 2 when F2 is greater than F1.

Once the first powder reservoir 2 is filled, the first powder reservoir 2 is moved in a horizontal direction over the base plate 5 towards a process region 100 of the device, indicated by a dashed arrow, wherein the base plate 5 is interrupted above a substrate 3 in the process region 100. The substrate 3 has an upper side 3a. A scanner with deflection mirrors 4.2 for deflecting a dashed laser beam 4 of the laser 4.1 is arranged above the substrate, wherein the laser 4.1 is not yet operating here.

When passing over the base plate 5 and the substrate 3, a constant force F1 acts on the agglomerating material 1 in the first reservoir 1.

FIG. 3 schematically shows the step of the method according to the invention when applying a first powder layer S1 to the upper side of the substrate 3a in which the first powder reservoir 2 is moved over the upper side Sa of the base plate 5 and the upper side 3a of the substrate 3, here in the direction of the arrow to the right.

The first powder reservoir 2 moves over the substrate 3, the upper side 3a of which is slightly below the upper side 5a of the base plate 5, preferably exactly in the layer thickness of the first powder layer S1 to be produced or in the order of magnitude of the layer thickness to be produced. With further downward axial force applied to the pulverulent agglomerating material 1 by means of the plunger 6, it is applied to the upper side of the substrate 3 with the force F1, wherein the agglomerating material 1 behaves like a fluid.

A first powder layer S1 of the material 1 remains on the upper side 3a of the substrate 3. The upper side 1a of the first powder layer S1 forms the processing plane for the selective melting of the first powder layer S1 by means of the laser beam 4 indicated here, after the substrate 3 has been provided with the first powder layer S1 over its entire surface.

After application, the upper side 1a of the first powder layer S1 lies in particular slightly above the upper side 5a of the base plate 5 and is preferably 20 to 200 μm higher than the upper side Sa of the base plate 5.

The upper side 3a of the substrate preferably has a surface finish that ensures that the first powder layer S1 of the pulverulent material 1 remains in place over the entire surface.

The laser 4.1 and the deflection mirror 4.2 of the scanner are arranged above the substrate 3.

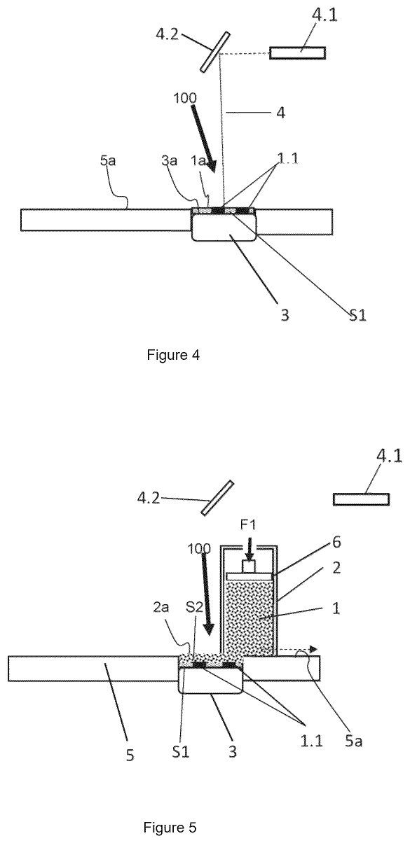

After the first powder reservoir 2 has been moved completely over the substrate 3, the first powder layer S1 of the pulverulent material 1 applied to the substrate 3 is selectively melted by means of the laser beam 4 of the laser 4.1 and its deflection by means of the scanner 4.2 at the positions which are to be solidified, whereby a solid laser-sintered metal layer 1.1 is formed after cooling, at least in some areas (see FIG. 4).

The substrate 3 is now lowered according to the required layer thickness of the next powder layer to be produced (see FIG. 5) and a further powder layer, in this case a second powder layer S2 made of the pulverulent material 1, is applied to the first layer S1 by an axial movement (dashed arrow) of the first powder reservoir 2, wherein the force F1 also acts. The upper side 2a of the second powder layer S2 now forms the new processing plane. The second layer S2 is then partially melted so that a solid laser-sintered metal layer is formed, at least in some areas.

During the horizontal movement of the first powder reservoir 2 over the base plate 5, the pulverulent material 1 located in the first powder reservoir 2 is preferably further compressed by the first means 6 for generating an axial force F1 and is subjected to the constant force F1 in the direction of the base plate 5 and the substrate 3 or the applied laser-sintered layer. The base plate 5 is preferably designed in such a way that no or almost no powder material 1 remains on the base plate 5 while the first powder reservoir 2 passes over it.

The laser 4.1 is preferably a fiber laser. For example, an infrared laser or a laser with a different wavelength is used. It may also be possible to optionally use a different energy source, for example electron beams or beams emitted by LEDs.

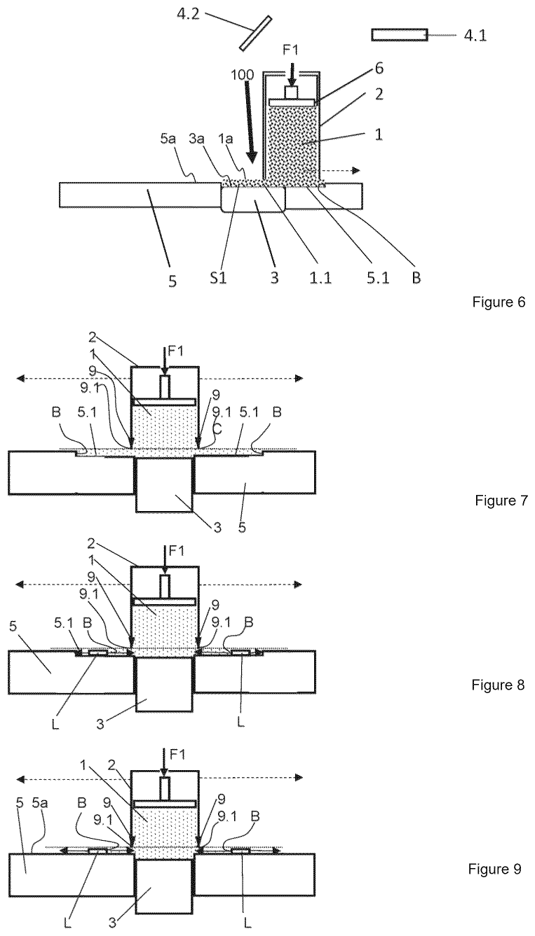

FIG. 6 shows a variant of the device according to the invention, in which the base plate 5 has a depression 5.1 next to the substrate 3 in the direction of application (direction of arrow), through which a barrier B is formed. This prevents the powder from being applied to the upper side Sa of the base plate 5.

The upper side 1a of here the first layer S1, which is applied to the upper side 3a of the substrate 3, also forms the processing plane above the substrate 3.

The upper side 1 a is also preferably 20 μm to 200 μm above the upper side 5a of the substrate 3.

In the variant shown in FIG. 6, the powder in the form of the agglomerating material 1 is applied unidirectionally in the direction of the arrow, with the first force F1 acting.

Laser sintering is then carried out and the next powder layer is applied in the direction of the arrow. The return movement of the first powder reservoir 2 takes place against the direction of the arrow before or after laser sintering. No powder layer is applied during the return movement in the unidirectional mode of operation.

In a further variant, the powder 1 is applied and then partially melted when the powder reservoir 2 is moved back and forth in each direction. The powder 1 is thus applied in a first direction and partially melted and then applied in the other direction and then partially melted. In this bidirectional application, in which the first force F1 always acts on the agglomerating material 1, the squeegees 9 present on the underside of the reservoir preferably have the same height at their lower edges 9.1 (see FIGS. 7-9) The substrate 3 is lowered before each powder layer is applied.

With this bidirectional order, a barrier B can be provided in each order direction.

FIG. 7 shows a variant for bidirectional application, in which there is also a depression 5.1 in the base plate 5, which here extends on both sides of the substrate 3, whereby a barrier B in the form of a shoulder is formed in both directions of movement of the first reservoir 2.

According to FIG. 8, a barrier B is formed by bars L, which are arranged in the depression 5.1 of the base plate 5 on both sides of the substrate 3 and transverse to the direction of movement of the first powder reservoir 2. The sides of the bars L pointing in the direction of the second powder reservoir 2 form the barrier B.

FIG. 9 shows an embodiment variant in which the base plate 5 has no depression, wherein the bars L on the upper side Sa of the base plate 5 are also positioned on both sides of the substrate 3 and, with their sides facing the second powder reservoir 2, also form a barrier B for the powder layer of powder 1 to be applied.

In the three aforementioned variants, the powder 1 is applied bidirectionally by means of the first reservoir 2, i.e. alternately back and forth in the direction of the dashed arrows.

When using, for example, bars L with barrier B as shown in FIGS. 8 and 9, it is possible to adjust the bars L in the direction towards and away from the substrate 3, which is indicated by the arrows. This location-adjustable arrangement of the barrier(s) B makes it possible to adapt the distance of the barrier B to the substrate 3 to the coating properties of the powder 1 or the agglomerating properties of the powder 1.

According to embodiment variants not shown, the use of the location-adjustable barrier can also be used for unidirectional application according to FIG. 6.

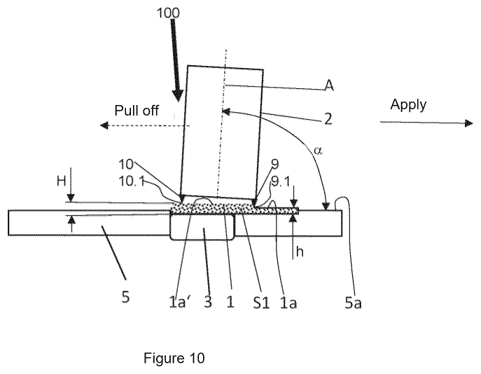

In the variant shown in FIG. 10, the pulverulent material is applied in one direction with a greater height and then drawn off in the opposite direction to the desired height h. The pulverulent material 1 is applied unidirectionally from left to right and removed from right to left.

For this purpose, the powder reservoir 2 has a first squeegee 9 with a lower edge 9.1 at the bottom in the direction of application and a second squeegee 10 with a lower edge 10.1 opposite to this in the direction of removal (direction of arrow), wherein the lower edge 9.1 of the first squeegee 9 is at a smaller distance from the upper side Sa of the base plate 5 than the lower edge 10.1 of the second squeegee 10.

When passing over the substrate 3 in the application direction, in this case to the right, a higher first layer S1 with a higher upper side 1a′ is applied to the substrate 3, corresponding to the height of the second squeegee 10. During subsequent removal in the opposite direction, in this case to the left, the powder is removed to the height of the processing level 1a by means of the first squeegee 9 and then melted.

The different heights of the squeegees 9, 10 can be set, for example, by tilting the powder reservoir 2 by an angle α between a longitudinal axis A of the reservoir 2 and the upper side Sa of the base plate 5 in the application direction.

When the first reservoir 2 is retracted in the pull-off direction, the excess powder is equalized/pulled off to the correct height h by means of the first squeegee 9.

The powder 1 can then be melted in the processing plane of the upper side 1a of the first layer S1, which is located above the substrate 3.

The height H of the applied powder 1 in the unidirectional application described above for FIG. 10 is approximately 2 to 10 times the height h of the removed layer S1 . . . S2 etc.

The layer thickness of the respective equalized layer S1, S2 . . . etc. before laser processing is preferably one to four times the particle size of the powder 1.

After completion of the micro part or micro component, the micro part or micro component is separated from the substrate 3, for example by wire erosion.

The substrate is preferably made of a metallic material, e.g. stainless steel, titanium or ceramic. After separating a component from the substrate, the surface of the substrate can be processed so that it can be reused as a substrate in a further process for manufacturing micro components. For this purpose, its surface is ground over, for example, and then structured using a laser, for example.

### LIST OF REFERENCE NUMERALS

### Reference Signs for FIG. 1—Prior art

1′ Pulverulent material
2′ Powder reservoir
3′ Substrate
4′ Laser beam
B Component
M Three-dimensional CAD model

### Reference Signs for FIGS. 2 to 7

1 Pulverulent material
   1a Upper side of the first powder layer S1/processing plane
   1a′ Upper side of layer S1 applied in the direction of application
   1.1 Solid laser-sintered metal layer
2 First powder reservoir
   2a Upper side of the second powder layer S2/processing plane
3 Substrate
   3a Upper side of the substrate
4 Laser beam
4.1 Laser
4.2 Deflection mirror of the scanner
5 Base plate
   5.1 Depression
   5a Upper side of the base plate
6 First means of generating an axial force
7 Second powder reservoir
8 Second means of generating an axial force
9 First squeegee
   9.1 Lower edge of the first squeegee
10 Second squeegee
   10.1 Lower edge of the second squeegee
   100 Process region
   200 Filling region
   B Barrier
   F1 First axial force
   F2 Second axial force
   L Bar
   S1 First layer
   S2 Second layer
   α Tilt angle

1.-19. (canceled)

20. Method for producing micro components and micro parts by additive manufacturing by means of micro laser sintering, wherein a pulverulent agglomerating material (1) is applied in layers from a first powder reservoir (2) and is melted by means of a laser beam (4) after application, characterized in that the material (1) located in the first powder reservoir (2), which is open in the direction of a processing plane, is agglomerating powder, the particle size (1) of which is at most 20 μm, and in that the agglomerating material (1) is subjected to a constant first force (F1) during an entire application process in the direction of a substrate (3), a process region and a base plate (5), as a result of which the agglomerating material (1) behaves like a fluid during application, wherein the force (F1) is 5 N to 50 N at least during the application process of the agglomerating material (1).

21. Method according to claim 20, characterized in that the force (F1) acts both when filling the first powder reservoir (2) and when passing over a base plate (5) and the substrate (3) in the process region (100), wherein the first powder reservoir (2) is filled from a second powder reservoir (7) in a filling region (200) which is arranged below the processing plane and is designed to be open in the direction of the processing plane, wherein in the second powder reservoir (7) an axial second force (F2) acting in the direction of the processing plane acts on the pulverulent material (1) located in the interior and the pulverulent material (1) is pressed out of the second powder reservoir (7) arranged below the filling region (200) into the first powder reservoir (2) located above the filling region (200) by an interruption of the base plate (5) in the filling region (200), when the second force (F2) in the second powder reservoir (7) is greater than the first force (F1) in the first powder reservoir (2).

22. Method according to claim 20, comprising the steps of:
a. compacting of the pulverulent material (1) in a first powder reservoir (2) open in the direction of a processing plane by exerting axial pressure with the first force (F1) on the pulverulent agglomerating material (1) in the direction of the substrate (3) in the process region (100);
b. application and formation of a first powder layer of the pulverulent agglomerating material (1) on the structured upper side (3a) of the substrate (3) by moving the first powder reservoir (2) parallel to the upper side of the substrate (3a) while simultaneously exerting force on the pulverulent agglomerating material (1) in the direction of the upper side (3a) of the substrate (3);
c. selective melting of the first powder layer (S1) by a laser beam (4);
d. lowering the substrate (3), and
e. application of the compacted pulverulent agglomerating material (1) from the first powder reservoir (2) with simultaneous application of force to the pulverulent material (1) on the first selectively melted powder layer or on further already formed and selectively melted powder layers and formation of further powder layers which are selectively melted until the micro part or the micro component is completed, wherein the substrate (3) is lowered before the application of each further powder layer.

23. Method according to claim 20, characterized in that the first powder reservoir (2) is moved horizontally over a base plate (5) and the substrate (3) after filling with the pulverulent agglomerating material (1) and compacting the pulverulent material (1), wherein the constant first force (F1) acts.

24. Method according to claim 20, wherein after completion of the micro part or the micro component, the micro part or the micro component is separated from the substrate (3), wherein the separation is preferably carried out by means of wire erosion.

25. Method according to claim 20, wherein an infrared fiber laser is used to melt the first and/or further powder layers of the agglomerating material (1).

26. Method according to claim 20, wherein a metallic or ceramic material is used as the agglomerating agglomerating material (1) in powder form.

27. Device for carrying out a method according to claim 20, wherein the device has a horizontally aligned base plate (5) which is interrupted at least in certain regions in a process region (100) above a substrate (3) and has a first powder reservoir (2) which is arranged above the base plate (5) and can be moved horizontally above the base plate (5) and has an interior for accommodating a pulverulent agglomerating material (1), characterized in that the first powder reservoir (2) is designed to be open in the direction of the base plate (5) and of a substrate (3) arranged inside the base plate (5), and wherein the first powder reservoir (2) has in its interior first means (6) for generating a constant axial first force (F1) acting in the direction of the base plate (5) and of the substrate (3) on the pulverulent agglomerating material (1) located in the interior and has a particle size of at most 20 μm, as a result of which the agglomerating material (1) behaves like a fluid at least in the process region (100), wherein the first force (F1) is 5 N to 50 N.

28. Device according to claim 27, characterized in that the first powder reservoir (2) has in its interior first means (6) for generating the axial force (F1) acting in the direction of the base plate (5) and the substrate (3) on the pulverulent agglomerating material (1) located in the interior, which also acts in a filling region (200) when filling the first powder reservoir (2), and in that the device has a second powder reservoir (7) with an interior for accommodating a pulverulent agglomerating material (1), wherein the second powder reservoir (7) has second means (8) for generating a second force (F2) acting in the direction of the first powder reservoir (2) on the pulverulent material (1) located in the interior, wherein the base plate (5) has an interruption in the filling region (200) and both the first powder reservoir (2) and the second powder reservoir (7) are designed to be open towards the base plate (5) and the pulverulent agglomerating material (1) can be pressed from the second powder reservoir (7) arranged below the filling region (200) into the first powder reservoir (2) located above the filling region (200), if the second force (F2) in the second powder reservoir (7) is greater than the first force (F1) in the first powder reservoir (2).

29. Device according to claim 27, characterized in that the device has, in the process region (100), a substrate (3) which is arranged below a processing plane and has a structured upper side (3a) for accommodating a first powder layer (S1), wherein the processing plane is formed by the upper side (1a) of the pulverulent material (1) applied in the region of the substrate (3).

30. Device according to claim 27, characterized in that an upper side (3a) of the substrate (3) is structured in such a way that the structure of the substrate surface is adapted to the particle size of the pulverulent agglomerating material (1), wherein the structuring has depressions whose size corresponds to 0.5 times to eight times the particle size of the pulverulent material.

31. Device according to claim 27, characterized in that it has a base plate (5) arranged below the processing plane.

32. Device according to claim 27, characterized in that the base plate (5) has a depression (5.1) next to the substrate (3) in the direction of application, by means of which a barrier (5.2) is formed which prevents the powder from being pushed beyond it.

33. Device according to claim 27, characterized in that the first powder reservoir (2) has squeegees (9) on both sides of the first powder reservoir (2) in the case of bidirectional powder application transverse to the direction of movement, the lower edges (9.1) of which squeegees have the same distance from the upper side (5a) of the base plate (5).

34. Device according to claim 27, characterized in that, in the case of unidirectional powder application, the first powder reservoir (2) has a first squeegee (9) in one application direction and a second squeegee (10) in an opposite take-off direction, wherein the lower edge (9.1) of the first squeegee (9) is at a smaller distance from the upper side (5a) of the base plate (5) than the lower edge (10.1) of the second squeegee.

35. Device according to claim 27, characterized in that the second powder reservoir (7) is designed in the form of a cartridge prefilled with powder, the base of which can be displaced by a motor in the direction of the first powder reservoir by means of the second force (F2).

36. Device according to claim 27, further comprising a laser and scanner (4.1) for melting the first powder layer and/or further powder layers and for structuring the substrate (3).
